(19) United States
(12) Patent Application Publication
(10) Pub. No.: US 2014/0129765 A1
(43) Pub. Date: May 8, 2014

(54) METHOD TO IMPROVE DATA RELIABILITY IN DRAM SSD USING ASYNCHRONOUS LOGGING AND INCREMENTAL BACKUP

(71) Applicant: TAEJIN INFO TECH CO., LTD., Seoul (KR)

(72) Inventor: Byungcheol CHO, Seoul (KR)

(73) Assignee: TAEJIN INFO TECH CO., LTD., Seoul (KR)

(21) Appl. No.: 13/671,013

(22) Filed: Nov. 7, 2012

(51) Int. Cl. G06F 12/16

(52) U.S. Cl. 711/105; 711/E12.103

(57) ABSTRACT

Data back-up and recovery methods for DRAM SSDs and other high performance disks are provided. During operation, write events to the DRAM SSD are asynchronously backed-up onto a back-up HDD storage disk from an in-memory buffer. Should a DRAM SSD failure occur, the system can continue to operate, albeit at a lower performance, using the back-up HDD storage disk. Should the main power fail, data remaining in the in-memory buffer is flushed to the back-up HDD storage disk and writing events that did not make it to the in-memory buffer due to insufficient space are incrementally backed-up from the DRAM SSD to the secondary storage. Once power returns from the main power, data from the back-up storage disk and the secondary storage are transferred to the DRAM SSD.

### BACKGROUND

A solid state disk (SSD) is a storage medium that does not have moving or rotating parts. Instead, an SSD generally uses flash memory or a volatile memory such as DRAM (dynamic random access memory) to store data. A DRAM SSD provides ultrafast data access. Indeed, DRAM SSDs are faster than current flash-based SSDs and hard disk drives (HDDs). In addition, the low latency for reading and writing (the time it takes for an input or output request to complete, i.e., response time) also makes DRAM SSDs attractive for many high IOPS (the number of input or output (IO) requests per second) applications. DRAM SSDs are also useful for applications that are write intensive or have random write behavior because of DRAM SSDs' high endurance (as compared to flash).

However, DRAM is a volatile memory requiring power to operate. Therefore, to retain data (e.g., provide data persistence), DRAM SSDs incorporate back-up storage systems (such as an HDD) and a secondary power source (such as a battery, super capacitor or AC/DC power adapter) to enable data to be copied (and stored) in a back-up storage when no power is being supplied from a primary power source.

### BRIEF SUMMARY

Disclosed herein are techniques and systems for data back-up and restoration that not only minimize data loss from volatile DRAM SSDs in emergencies such as power failure, but also improve system availability when the DRAM SSD equipment is in fault. In addition, the techniques and systems described herein are configured to minimize adverse impact on performance during failure-free operation.

According to one embodiment, a system is provided including a DRAM SSD, a back-up storage disk, a secondary storage, and a secondary power source. During operation, write events are asynchronously backed-up onto the back-up storage disk from an in-memory buffer. Should a DRAM SSD failure occur, the system can continue to operate using the back-up storage disk. Should the main power fail, the secondary power source can provide power to enable data remaining in the in-memory buffer to be flushed to the back-up storage disk and enable writing events that did not make it to the in-memory buffer due to insufficient space to be incrementally backed-up from the DRAM SSD to the secondary storage. Once power returns from the main power, data from the back-up storage disk and the secondary storage is transferred to the DRAM SSD.

According to a further embodiment, a memory buffer manager is provided to manage the system memory assigned as the in-memory buffer and flush the in-memory buffer when the main power fails; and a buffered logging manager is provided to log the data from the in-memory buffer to the back-up storage disk. In yet a further embodiment, an I/O event manager is provided to manage input and output events to the DRAM SSD, record write events that occur to the DRAM SSD but do not make it to the in-memory buffer due to the insufficient space available, and notify the DRAM SSD controller of the writing events that did not make to the in-memory buffer in order to enable these events to be incrementally backed-up from the DRAM SSD to the secondary storage. A recovery manager can be provided to restore the data in the back-up storage disk and the secondary storage to the DRAM SSD.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows a diagram illustrating architecture of a system for data back-up and restoration according to an embodiment of the invention.

FIG. 2 shows a diagram illustrating normal operation including data back-up in accordance with an embodiment of the invention.

FIG. 3 shows a diagram illustrating operation upon power failure in accordance with an embodiment of the invention.

FIG. 4 shows a diagram illustrating a restore operation in accordance with an embodiment of the invention.

### DETAILED DISCLOSURE

Methods and systems for data back-up and restoration of are provided. Embodiments of the invention utilize a combination of asynchronous and incremental back-ups. For the asynchronous back-up, an HDD or flash array (or other non-volatile memory) along with an in-memory buffer is used. In addition, a separate incremental back-up is provided to another non-volatile storage. This other non-volatile storage can be of smaller size than the HDD or flash array used for the asynchronous back-up.

According to one aspect of the invention, data loss in a volatile DRAM SSD due to emergencies including power failure can be inhibited from occurring. In a further aspect, input-output service is maintained even when the DRAM SSD equipment is in fault, improving system availability. In addition, the data back-up techniques described herein do not adversely impact performance during failure-free operation, maintaining the performance of the DRAM SSD during normal operation.

In a conventional back-up system, data back-up occurs in a synchronous manner, off-line, or at periodic intervals (such as when asynchronous back-ups are performed).

In more detail, back-up from a primary storage to a replication target is generally performed through synchronous back-up or asynchronous back-up. Synchronous back-up or replication performs a write operation to the two locations atomically (i.e., concurrently). That is, a write operation is not considered complete until both locations (e.g., the local, primary storage and the replication target) indicate that the write transaction is complete. Because applications generally wait for the write transaction to be indicated as complete before proceeding to the next transaction or process, system performance can suffer due to the extra delay in waiting for completion of the two write transactions (and particularly the transaction and acknowledgement latency from the replication target when located remotely). Synchronous back up is considered a safe option because failure of either of the two storage media generally results a freeze in writing (and, in most cases, a zero data loss).

In asynchronous backup or replication, the write operation is considered complete once the local, primary storage acknowledges a completed write transaction. Remote storage (i.e., the replication target) is written to with a lag. For example, asynchronous back-up is performed by first storing (i.e. writing) data to primary storage, holding a copy of data to be backed-up in a second memory (which may be in-memory) and copying the data to be backed up to a replication target in real-time or at scheduled intervals. The replication target can be located remotely and the data transmitted to the replication target over a network.

In contrast with the synchronous back-up techniques, the delay in writing to the remote storage can result in the remote storage not guaranteed to have the most current copy of the data. Therefore, in a conventional asynchronous back-up system it is not possible to restore data if an abrupt primary storage error (e.g., an error with the DRAM SSD and/or the power) occurs between back-ups.

Embodiments of the invention address this issue by performing a real-time back-up by using asynchronous buffered logging with an in-memory buffer to achieve the latency advantages of asynchronous back-up as well as using synchronous back-up during certain conditions to ensure the security/reliability of the data during an emergency such as abrupt power failure.

Instead of relying only on a back-up at designated intervals (online or off-line) or performance-restricting synchronous back-ups, embodiments provide a coordinated effort to facilitate a 100% data restoration while minimizing adverse effects to normal operating performance.

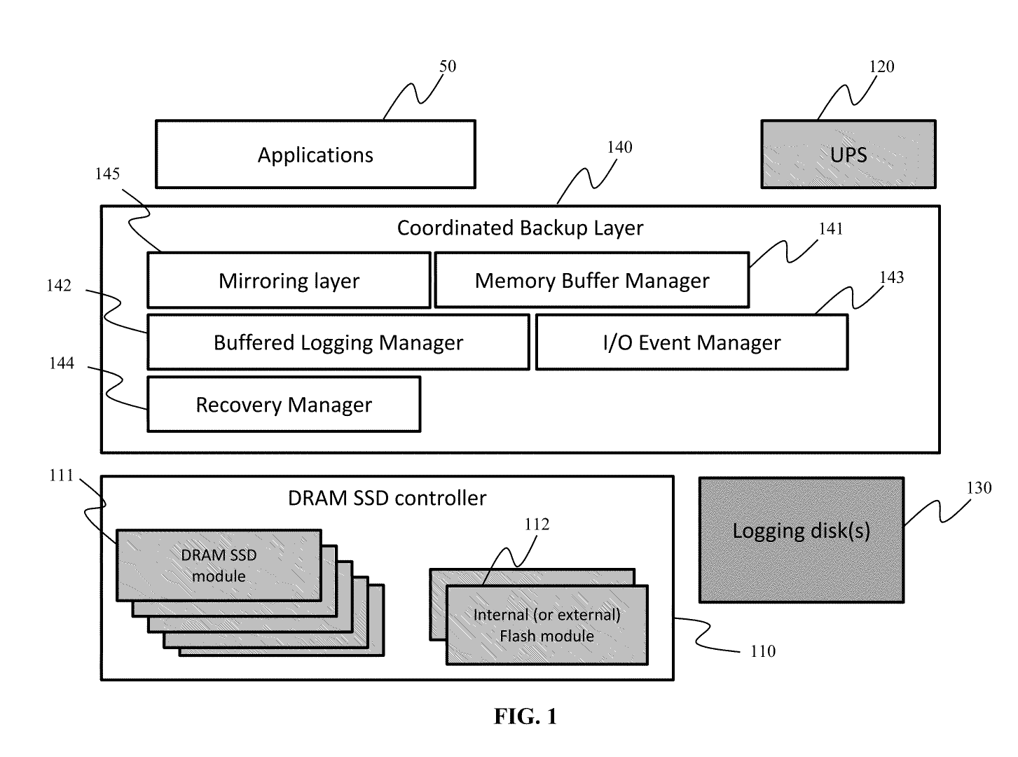

FIG. 1 shows a diagram of a system architecture in accordance with an embodiment of the invention. As shown in FIG. 1, a system for data back-up and restoration in accordance with an embodiment of the invention includes a DRAM SSD controller 110, a local uninterruptable power source (UPS) 120 (e.g., battery, capacitor), and a logging disk (or array) 130. Although not shown, the DRAM SSD controller 110 can be connected to a host on which an operating system and applications (e.g., applications 50) are run. The host can include a computer system with hardware including one or more computer processing units (CPUs), system memory, mass storage (e.g., hard drive), and I/O devices (e.g., network interface, user input devices). Elements of the computer system hardware can communicate with each other via a bus. In certain embodiments, one or more digital signal processors (DSPs) may be included as part of the computer hardware of the system in place of or in addition to a general purpose CPU.

The DRAM SSD controller 110 can include a processor (not shown), firmware read-only memory (ROM) (not shown), a host interface (not shown), at least one DRAM SSD module 111 and one or more flash modules 112. The host interface may be any suitable interface including, but not limited to SCSI, SATA, USB, SAS, PCI, or PCIe. Other hardware can also be included as part of the controller 110. The logging disk(s) 130 can include an HDD, HDD array, or a non-volatile memory such as flash. The logging disk(s) 130 may be local or networked.

For embodiments where one or more components (including logging disk(s) 130) of the system communicate over a network, the network may be any suitable communications network including, but not limited to, a cellular network, the Internet, a local area network (LAN), a wide area network (WAN), a WiFi network, a satellite network, or a combination thereof. Such networks are widely used to connect various types of network elements, such as routers, servers, and gateways. It should also be understood that the invention can be practiced in a multi-network environment having various connected public and/or private networks. As will be appreciated by those skilled in the art, communication networks can take several different forms and can use several different communication protocols.

In accordance with various embodiments of the invention, a coordinated back-up layer 140 is provided for controlling and coordinating data back-up and restoration. The coordinated back-up layer includes a memory buffer manager 141, a buffered logging manager 142, an I/O event manager 143, and a recovery manager 144. In a further embodiment, a mirroring layer 145 can be included to transfer data to two locations.

The coordinated back-up layer 140 can be implemented as executable instructions performed by the processor (not shown) of the host (not shown), the processor (not shown) of the DRAM SSD controller 110, or a combination of both. Further, executable instructions implementing the coordinated back-up layer 140 can be stored on a computer readable medium. In certain embodiments, the executable instructions may be stored as part of the firmware of the DRAM SSD controller or a driver provided in the operating system of the host (and stored along with the operating system on a memory or mass storage of the host), or a combination thereof.

It should be appreciated by those skilled in the art that computer-readable media include removable and non-removable structures/devices that can be used for storage of information, such as computer-readable instructions, data structures, program modules, and other data used by a computing system/environment. A computer-readable medium includes, but is not limited to, volatile memory such as random access memories (RAM, DRAM, SRAM); and non-volatile memory such as flash memory, various read-only-memories (ROM, PROM, EPROM, EEPROM), magnetic and ferromagnetic/ferroelectric memories (MRAM, FeRAM), and magnetic and optical storage devices (hard drives, magnetic tape, CDs, DVDs); or other media now known or later developed that is capable of storing computer-readable information/data. Computer-readable media should not be construed or interpreted to include any propagating signals.

Further, certain techniques set forth herein may be described in the general context of computer-executable instructions, such as program modules, executed by one or more computers or other devices. Certain embodiments of the invention contemplate the use of a computer system or virtual machine within which a set of instructions, when executed, can cause the system to perform any one or more of the methodologies discussed above. Generally, program modules include routines, programs, objects, components, and data structures that perform particular tasks or implement particular abstract data types.

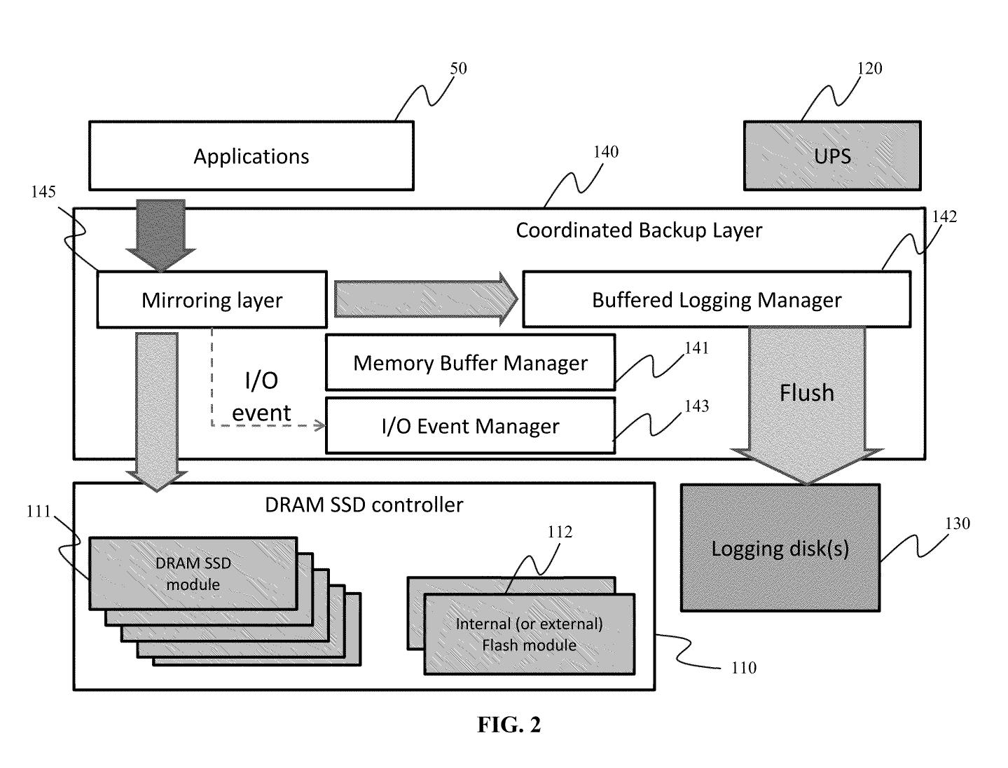

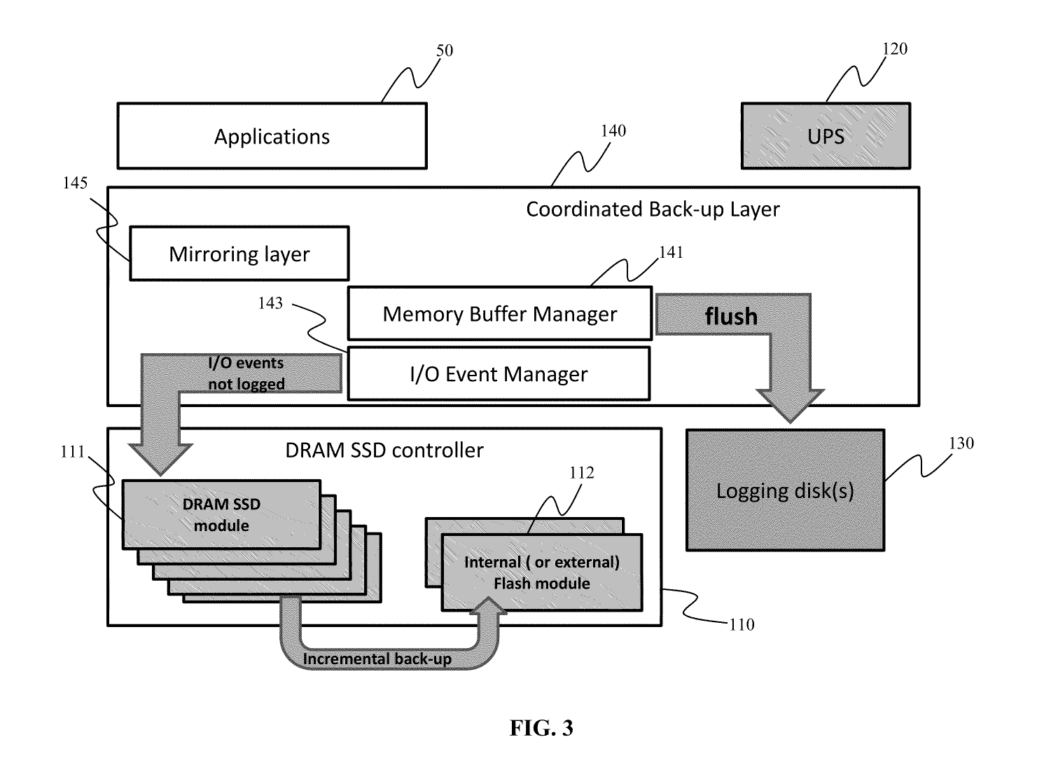

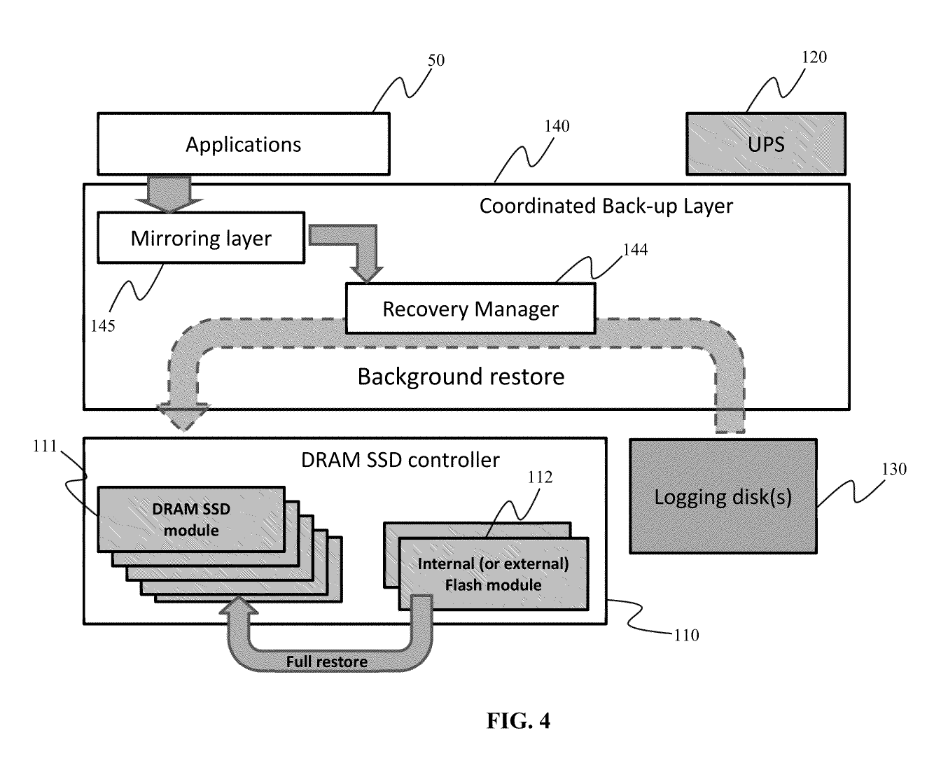

FIGS. 2-4 illustrate system operations in accordance with various embodiments of the invention. FIG. 2 shows normal operation; FIG. 3 shows operation upon power failure; and FIG. 4 shows a restore operation.

In accordance with various embodiments of the invention, the buffered logging manager 142 and the memory buffer manager 141 are provided to maintain an asynchronous back-up to HDD and/or flash array (logging disk(s) 130) using an in-memory buffer. The in-memory buffer can be a portion of the main memory of the computer system.

As shown in FIG. 2, asynchronous backup is performed during normal operation. According to one embodiment, a mirroring layer 145 is used to interface with applications 50 running on a host. Mirroring backs-up or replicates data on a local level. When referring to a back-up process occurring across a network to storage at a remote location, the term replication is generally used. A conventional mirroring (or replication) system involves two storage media (e.g., two memories) having the same performance characteristics and, often, being physically identical. As a network failover solution, the mirroring/replication generally is active-active (both equipment are online and pass traffic under normal conditions) or active-standby (one equipment passes traffic while the other sits idle until needed).

However, because there is no non-volatile back-up storage having performance capabilities corresponding to DRAM SSDs or other fast-performing equipment such as a JetSpeed memory (JSM), using mirroring alone (via mirror layer 145) to back-up data will either reduce performance (due to using a back-up storage having a lower performance than the DRAM SSD) or suffer the similar risks of power failure (due to using a back-up storage also being formed of volatile memory).

Therefore, as shown in FIG. 2, embodiments of the invention incorporate an asynchronous back-up in order to use a non-volatile memory while maintaining performance of the fast performing equipment (e.g., the DRAM SSD).

According to an embodiment, a hard disk is made to perform a writing function at a maximum capability by using asynchronous buffered logging, accomplishing a similar performance in random writing compared with JSM.

The asynchronous back-up of embodiments of the invention utilize the memory buffer manager 141 and the buffered logging manager 142. According to one embodiment, asynchronous back-up is performed with respect to the DRAM SSD module 111 and the logging disk(s) 130 of an HDD or flash array.

The mirroring layer 145 duplicates (mirrors) write requests from applications 50 and issues the write requests into both the DRAM SSD module 111 and the logging disk(s) 130. The mirroring layer 145 may be implemented as executable instructions performed, for example, by a host processor (e.g., a software RAID-1 design). The mirroring layer 145 may be implemented as part of the host operating system (for example, as part of the operating system's kernel layer).

In accordance with an embodiment, the data read or write event (from an application 50) is provided to the DRAM SSD module 111 via the mirroring layer 145. The data transferred (to be written) via the mirroring layer 145 is also held in the in-memory buffer, which holds a copy of data before performing the back-up to the logging disk 130 under the control of the buffered logging manager 142.

In addition to sending data to the DRAM SSD module 111 and sending data to the logging disk(s) 130 through the in-memory buffer (and memory buffer manager 141 and buffered logging manager 142), the mirroring layer 145 provides information regarding I/O events to the I/O event manager 143. The asynchronous back-up of embodiments of the invention incorporates the benefits of asynchronous back up to HDD or flash array, which is the enhanced system performance (as compared to synchronous back-ups) and low cost.

The memory buffer manager 141 manages the system memory (in-memory) assigned as buffer. In certain embodiment, the memory buffer manager 141 coordinates the memory allocation for the data being buffered and can keep track of available memory space of the buffer.

The buffered logging manager 142 logs buffered data to disks and controls the collection/transfer of the buffered data to the logging disk 130 (performs the asynchronous back-up). The buffered logging manager 142 can cause the transfer of data from the buffer to the logging disk 130 according to a designated condition such at every a particular time period/interval or some other condition such as available memory space in the buffer.

During DRAM SSD failure, the logging disk(s) 130 can be used to continue operations. Although this configuration reduces the performance of the system during DRAM SSD failure, the HDD or flash array logging disks enables the system to continue to be available even while the DRAM SSD is in fault.

The I/O event manager 143 manages the input and output events by recording an event when the input/output event occurs only on the DRAM SSD 111 and the available memory of the buffer is insufficient to indicate the event occurred. For example, the buffer may have insufficient space in memory to store data associated with a particular write event because a transfer from the buffer to the logging disk 130 may not have occurred before the available memory space became insufficient.

FIG. 3 illustrates the operations for when power fails. Here, synchronous back-up is performed for the DRAM SSD module. As with the usual asynchronous back-up, when power fails, the memory buffer manager 141 flushes the buffer to the logging disks 130. The UPS 120 is used to enable the time for backing up data in the in-memory buffer (flushing to the HDD) upon power failure. In addition to the flushing from the buffer to the logging disks 130 (which may be carried out under the control of the memory buffer manager 141), the system performs an incremental back-up. According to an embodiment, the I/O event manager 143, which had been recording I/O events to an in-system memory, notifies the DRAM SSD controller 110 of non-recorded writing events (e.g., events not provided in the buffer to be flushed to the logging disk) so that the DRAM SSD controller 110 can perform an incremental back-up from the DRAM SSD module 111 to the internal (or external) flash module 112. The I/O event manager 143 enables the data that has not made it to the in-memory buffer to be saved in the non-volatile memory of the internal or external flash module 112.

In certain embodiments, the DRAM SSD controller 110 stores only increments of yet-to-be recorded data in a non-volatile storage within the lasting capability of the UPS 120 (or battery). The incremental back-up operations can be performed in under the 15 minutes generally available by the UPS 120 or battery.

Embodiments of the invention provide a coordinated back-up for DRAM SSD to HDD and flash in which asynchronous data back-up is performed to the HDD and incremental back-ups for data not yet recorded in the HDD are performed to a secondary non-volatile storage (the flash) from the DRAM SSD.

FIG. 4 illustrates data restoration in accordance with an embodiment of the invention. Referring to FIG. 4, the recovery manager 144 performs a restoration procedure when power is back. Data in the logging disks 130 is returned to the DRAM SSD module 111 and a full restore is accomplished by transferring data from the internal (or external) flash module 112.

In order to restore the transferred data, a first step occurs between the flash module 112 and the DRAM SSD module 111 in which data that did not get logged into the logging disk 130 (due to the disparity of the DRAM SSD and the logging disk) is copied back from the flash module 112 to the DRAM SSD module 111, assuring that the data that was not logged is restored. A second step occurs between the logging disk 130 and the DRAM SSD module 111. For the second step, logs from the disk(s) 130 are read and written to the DRAM SSD module 111. The second step can be performed in the background. During the background restore, the recovery manager 144 handles I/O requests from the SSD or logging disk when the up-to-date data is located on logging disk 130.

Because only the I/O events that did not get copied into the in-memory buffer are incrementally backed-up into the non-volatile memory in communication with the DRAM SSD, fewer non-volatile storages are needed in regard to data yet to be recorded in HDD from the DRAM SSD.

Advantageously, the data restoration capability of various embodiments of the invention can be accomplished with a lower cost as compared with a full back-up.

Various embodiments of the data back-up and recovery described herein can be implemented for applications including, but not limited to, providing back-up and restoration of memory data of systems equipped with mass storages; providing cost-efficient data back-up and restoration in emergencies with mass memory based database (MMDB); providing system service availability when the DRAM SSD is in fault; providing system service availability when a Flash SSD is in fault; and providing system service availability when other high-performance SSDs are in fault.

In accordance with certain embodiments of the invention, the durability of an internal flash SSD module can be guaranteed. The improvements to durability may be attributed to the decreased number of writes to the flash memory facilitated by the incremental backup to flash of certain embodiments of the invention as opposed to a full copy backup each time a back-up is performed.

Service can be secured through using the logging disk when the DRAM SSD is in fault. For example, the buffered logging manager (142) creates logs from an application's written data. A log consists of a log header and log payload (user data). The buffered logging manager 142 determines a particular log's position in a logging disk in order to minimize head seek (time for a head assembly on an actuator arm of a HDD to travel to the location where the data will be read or written) and rotational delays (the time for the rotation of a disk of a HDD to bring the desired disk sector under the head of the HDD). In a failure-free situation (e.g., where the DRAM SSD is operating properly), there is no read being performed from a logging disk (130). Obsolete data management is performed using an indirection map (a map between DRAM SSD position and the logging disk position) stored in system memory. The log header of each log facilitates reconstruction of the indirection map from the logging disk. Therefore, when the DRAM SSD fails, both the reads and the writes can be serviced with the logging disk. Performance degrades but I/O service does not stop.

Back-ups can be performed with fewer flash SSD modules than required for a full backup, which generally requires the same amount of flash modules as the dram SSD. Because a logging disk is provided to store the full data of the DRAM SSD including the obsolete data, the flash modules (112) can be used as the incremental backup storage only storing non-logged data. Therefore, fewer flash modules are needed than the flash modules needed for full-backup. By using fewer flash modules, enhanced cost-efficiency can be provided. Embodiments of the data back-up and recovery method are implemented and operated independently in a different level from cache.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

It should be understood that the examples and embodiments described herein are for illustrative purposes only and that various modifications or changes in light thereof will be suggested to persons skilled in the art and are to be included within the spirit and purview of this application.

What is claimed is:

1. A method of data back-up for a dynamic random access memory (DRAM) solid state disk (SSD), the method comprising:
performing asynchronous back-up to a logging disk using an in-memory buffer;
checking available memory space of the in-memory buffer; and
recording any writing event occurring on the DRAM SSD that is not stored in the in-memory buffer due to insufficient available memory space of the in-memory buffer into a DRAM SSD location.

2. The method of claim 1, wherein upon power failure, the method further comprises:
flushing data in the in-memory buffer to the logging disk; and
performing an incremental back-up from the DRAM SSD to a non-volatile memory module in communication with the DRAM SSD based on the writing event recorded to the DRAM SSD location.

3. The method of claim 2, wherein upon power recovery, the method further comprises:
copying data in the logging disks to the DRAM SSD module and transferring data from the non-volatile memory module to the DRAM SSD to perform a full restore.

4. The method of claim 1, wherein upon DRAM SSD failure, the method further comprises using the logging disk to provide system service availability.

5. The method of claim 1, wherein the logging disk comprises a hard disk drive (HDD) or HDD array.

6. The method of claim 1, wherein the logging disk comprises non-volatile memory.

7. The method of claim 1, wherein performing the asynchronous back-up to the logging disk using the in-memory buffer comprises:
mirroring an event on the DRAM SSD to available memory space of the in-memory buffer such that data written to the DRAM SSD is stored as buffered data in the in-memory buffer; and
logging the buffered data to the logging disk at a designated condition.

8. The method of claim 7, wherein the designated condition is a periodic interval.

9. The method of claim 7, wherein the designated condition is based on an amount of available memory space in the in-memory buffer.

10. A coordinated data back-up and recovery system, comprising:
a logging disk;
a non-volatile memory;
a memory buffer manager for managing a portion of system memory assigned as a buffer and flushing the buffer to the logging disk upon power failure, the buffer being for storing data to be logged onto the logging disk;
a buffered logging manager for controlling logging of data stored in the buffer to the logging disk;
an I/O event manager for managing input and output events of a solid state disk (SSD), recording input and output events including writing events that occur only in the SSD and which are not indicated as stored in the buffer due to insufficient available memory, and notifying the SSD of non-recording writing events to cause a controller of the SSD to perform an incremental back-up to the non-volatile memory; and
a recovery manager for performing a restoration of data to the SSD when power is recovered after power failure.

11. The coordinated data back-up and recovery system of claim 10, further comprising:
a mirroring layer receiving data or a request from applications in active-active or active-standby mode, providing the data or request to the SSD, and mirroring data to the buffer.

12. The coordinated data back-up and recovery system of claim 10, wherein the SSD is a dynamic random access memory (DRAM) SSD.

13. A computer system comprising:
a host comprising at least one host processor and a host memory;
a back-up power source;
a solid state disk (SSD) controller in communication with the host through an interface and comprising an SSD processor and at least one dynamic random access memory (DRAM) SSD module;
at least one non-volatile memory module;
a logging disk in communication with the host through a logging interface; and
a computer-readable medium comprising executable instructions for performing a method of data back-up and recovery comprising:
performing an asynchronous back-up to the logging disk using a portion of the host memory as an in-memory buffer;
checking available memory space of the in-memory buffer; and
recording any writing event occurring on the SSD that is not stored in the in-memory buffer due to insufficient available space of the in-memory buffer into a SSD location.

14. The computer system of claim 13, wherein the at least one non-volatile memory module is an internal memory back-up of the SSD controller.

15. The computer system of claim 13, wherein the at least one non-volatile memory module is an external memory back-up in communication with the SSD controller through an I/O interface of the SSD controller.

16. The computer system of claim 13, wherein the logging disk comprises a hard disk drive (HDD) or HDD array.

17. The computer system of claim 13, wherein a portion of the host memory provides the computer-readable medium comprising the executable instructions for performing the method of data back-up and recovery.

18. The computer system of claim 13, wherein the computer-readable medium further comprises executable instructions for performing the method of data back-up and recovery further comprising:
flushing data in the in-memory buffer to the logging disk upon a main power failure; and
performing an incremental back-up from the SSD to the at least one non-volatile memory module based on the writing event recorded to the SSD location upon the main power failure.

19. The computer system of claim 18, wherein the computer-readable medium further comprises executable instructions for performing the method of data back-up and recovery further comprising:
copying data in the logging disk to the at least one SSD module and transferring data from the at least one non-volatile memory module to the at least one SSD module to perform a full restore upon restoration of the main power.

20. The computer system of claim 1, wherein upon SSD failure, the host reads and writes to the logging disk.
